(19) United States
(12) Patent Application Publication
(10) Pub. No.: US 2026/0155092 A1
(43) Pub. Date: Jun. 4, 2026

(54) DISPLAY DEVICE AND ELECTRONIC DEVICE INCLUDING THE DISPLAY DEVICE

(71) Applicant: SAMSUNG DISPLAY CO., LTD., YONGIN-SI (KR)

(72) Inventors: NEUNG-BEOM LEE, YONGIN-SI (KR); GYUHYEON KIM, YONGIN-SI (KR); HYUN SIK HWANG, YONGIN-SI (KR); YONG-SIK JUNG, YONGIN-SI (KR)

(21) Appl. No.: 19/344,607

(22) Filed: Sep. 30, 2025

(30) Foreign Application Priority Data
Dec. 2, 2024 (KR) 10-2024-0176317

(51) Int. Cl. G09G 3/32

(52) U.S. Cl. CPC G09G 3/32; G09G 2310/0275; G09G 2330/021; G09G 2360/16

(57) ABSTRACT

A display device may include a display panel having a plurality of pixels, a data driver, and a driving controller configured to control the data driver, the driving controller may be further configured to calculate a first total grayscale value by summing grayscales corresponding to pixels of the plurality of pixels included in an N-th pixel row, where N is a positive integer, calculate a second total grayscale value by summing grayscales corresponding to pixels of the plurality of pixels included in an (N+1)-th pixel row, and change a first low grayscale to a second low grayscale among the grayscales corresponding to the pixels included in the N-th pixel row when the first total grayscale value is less than a first reference value and the second total grayscale value is greater than a second reference value which is greater than the first reference value.

### CROSS-REFERENCE TO RELATED APPLICATION(S

This application claims priority under 35 USC § 119 to Korean Patent Application No. 10-2024-0176317, filed on December 02, 2024 in the Korean Intellectual Property Office (KIPO), the entire disclosure of which is incorporated by reference herein.

### FIELD

Embodiments of the present disclosure relate to a display device and an electronic device including the display device.

### INTRODUCTION

A display device may include a display panel and a display panel driver. The display panel driver may include a gamma reference voltage generator. The gamma reference voltage generator may receive a first maximum voltage and a first minimum voltage. The gamma reference voltage generator may generate a second maximum voltage and a second minimum voltage based on the first maximum voltage and the first minimum voltage. The gamma reference voltage generator may generate a gamma reference voltage corresponding to a grayscale based on the second maximum voltage and the second minimum voltage.

A magnitude of a data voltage corresponding to 0-grayscale (e.g., black) may be set high to express the 0-grayscale regardless of pixel characteristics such as luminance or the like. A data voltage corresponding to 1-grayscale may be determined according to the pixel characteristics such as luminance or the like. For example, a difference between the data voltage corresponding to the 1-grayscale and the data voltage corresponding to the 0-grayscale may be the greatest among any two consecutive grayscales. Accordingly, a difference between the data voltage corresponding to the 0-grayscale and a data voltage corresponding to 255-grayscale (e.g., white for 8-bit image data) may be greater than a difference between the data voltage corresponding to the 1-grayscale and the data voltage corresponding to the 255-grayscale.

When the data voltage toggles between the data voltage corresponding to the 0-grayscale and the data voltage corresponding to the 255-grayscale, a data voltage which is less than the data voltage corresponding to the 0-grayscale may be transmitted to an edge of the display panel by a delay, overshoot, or the like. Moreover, a data voltage which is greater than the data voltage corresponding to the 255-grayscale may be transmitted to the edge of the display panel by the delay, overshoot, or the like. For example, the data voltage corresponding to the 0-grayscale or the data voltage corresponding to the 255-grayscale might not be accurately transmitted to the edge of the display panel due to the delay, overshoot, or the like. For example, when the data voltage toggles between the data voltage corresponding to the 0-grayscale and the data voltage corresponding to the 255-grayscale, pixels located at the edge of the display panel might not accurately emit light at a luminance corresponding to the 0-grayscale and a luminance corresponding to the 255-grayscale, respectively. Accordingly, display quality of the display device may be sub-optimal.

In addition, when the data voltage for a first side of one pixel row is the data voltage corresponding to a first grayscale (e.g., 128-grayscale) and the data voltage for a second side of the one pixel row toggles between the data voltage corresponding to the 0-grayscale and the data voltage corresponding to the 255-grayscale, the gamma reference voltage, which is output from the gamma reference voltage generator, may be momentarily decreased. For example, the gamma reference voltage may be momentarily decreased so that the data voltage for the first side may be decreased. After the data voltage for the first side is momentarily decreased, the data voltage for the first side may be increased to a data voltage which is less than the data voltage corresponding to the first grayscale. Accordingly, the pixels of the first side might not emit light at the luminance corresponding to the first grayscale. Accordingly, the display quality of the display device may be sub-optimal.

### SUMMARY

An embodiment of the present disclosure may provide a display device having optimized display quality.

An embodiment of the present disclosure may provide an electronic device including the display device.

However, embodiments of the present disclosure are not necessarily limited to the above, and may be variously extended without departing from the scope and spirit of the present disclosure.

According to an embodiment, a display device may include a display panel having a plurality of pixels; a data driver configured to provide data voltages to the plurality of pixels; and a driving controller configured to control the data driver, the driving controller is further configured to calculate a first total grayscale value by summing grayscales corresponding to pixels of the plurality of pixels included in an N-th pixel row, where N is a positive integer, calculate a second total grayscale value by summing grayscales corresponding to pixels of the plurality of pixels included in an (N+1)-th pixel row, and change a first low grayscale to a second low grayscale among the grayscales corresponding to the pixels included in the N-th pixel row when the first total grayscale value is less than a first reference value and the second total grayscale value is greater than a second reference value which is greater than the first reference value.

According to an embodiment, a display device may include a display panel including pixels, a gate driver configured to provide gate signals to the pixels, a data driver configured to provide data voltages to the pixels, and a driving controller configured to control the gate driver and the data driver, the driving controller may be further configured to calculate a first total grayscale value by summing grayscales corresponding to the pixels included in an N-th pixel row, where N is a positive integer, to calculate a second total grayscale value by summing grayscales corresponding to the pixels included in an (N+1)-th pixel row, and to change a first low grayscale to a second low grayscale among the grayscales corresponding to the pixels included in the N-th pixel row when the first total grayscale value is less than a first reference value and the second total grayscale value is greater than a second reference value which is greater than the first reference value.

In an embodiment, the first low grayscale may be 0-grayscale.

In an embodiment, the second low grayscale may be 1-grayscale.

In an embodiment, the driving controller may be further configured to change the first low grayscale to the second low grayscale among the grayscales corresponding to the pixels included in the (N+1)-th pixel row when the second total grayscale value is less than the first reference value and the first total grayscale value is greater than the second reference value.

In an embodiment, the first low grayscale may be 0-grayscale.

In an embodiment, the second low grayscale may be 1-grayscale.

In an embodiment, the pixels may be configured to emit light of a substantially same color.

According to an embodiment, a display device may include a display panel having a plurality of pixels; a data driver configured to provide data voltages to the plurality of pixels; and a driving controller configured to control the data driver, wherein the driving controller is further configured to: calculate a first total grayscale value by summing grayscales corresponding to pixels of the plurality of pixels included in an N-th pixel row, where N is a positive integer; calculate a second total grayscale value by summing grayscales corresponding to pixels of the plurality of pixels included in an (N+1)-th pixel row; and change a first low grayscale to a second low grayscale among the grayscales corresponding to the pixels included in the (N+1)-th pixel row when the second total grayscale value is less than a first reference value and the first total grayscale value is greater than a second reference value which is greater than the first reference value.

According to an embodiment, a display device may include a display panel including pixels, a gate driver configured to provide gate signals to the pixels, a data driver configured to provide data voltages to the pixels, and a driving controller configured to control the gate driver and the data driver, the driving controller may be further configured to calculate a first total grayscale value by summing grayscales corresponding to the pixels included in an N-th pixel row, where N is a positive integer one, to calculate a second total grayscale value by summing grayscales corresponding to the pixels included in an (N+1)-th pixel row, and to change a first low grayscale to a second low grayscale among the grayscales corresponding to the pixels included in the (N+1)-th pixel row when the second total grayscale value is less than a first reference value and the first total grayscale value is greater than a second reference value which is greater than the first reference value.

In an embodiment, the first low grayscale may be 0-grayscale.

In an embodiment, the second low grayscale may be 1-grayscale.

In an embodiment, the driving controller may be further configured to change the first low grayscale to the second low grayscale among the grayscales corresponding to the pixels included in the N-th pixel row when the first total grayscale value is less than the first reference value and the second total grayscale value is greater than the second reference value.

In an embodiment, the first low grayscale may be 0-grayscale.

In an embodiment, the second low grayscale may be 1-grayscale.

In an embodiment, the pixels may be configured to emit light of a substantially same color.

According to an embodiment, an electronic device may include a processor configured to generate an input control signal and input image data; a memory device configured to store data information for an operation of the processor; a display panel having a plurality of pixels; a data driver configured to provide data voltages to the plurality of pixels; and a driving controller configured to control the data driver based on the input control signal and the input image data, wherein the driving controller is further configured to: calculate a first total grayscale value by summing grayscales corresponding to pixels of the plurality of pixels included in an N-th pixel row, where N is an integer greater than or equal to one; calculate a second total grayscale value by summing grayscales corresponding to pixels of the plurality of pixels included in an (N+1)-th pixel row; and change a first low grayscale to a second low grayscale among the grayscales corresponding to the pixels included in the N-th pixel row when the first total grayscale value is less than a first reference value and the second total grayscale value is greater than a second reference value which is greater than the first reference value.

According to an embodiment, an electronic device may include a processor configured to generate an input control signal and input image data, a memory device configured to store data information for an operation of the processor, a display panel including pixels, a gate driver configured to provide gate signals to the pixels, a data driver configured to provide data voltages to the pixels, and a driving controller configured to control the gate driver and the data driver based on the input control signal and the input image data, the driving controller may be further configured to calculate a first total grayscale value by summing grayscales corresponding to the pixels included in an N-th pixel row, where N is a positive integer, to calculate a second total grayscale value by summing grayscales corresponding to the pixels included in an (N+1)-th pixel row, and to change a first low grayscale to a second low grayscale among the grayscales corresponding to the pixels included in the N-th pixel row when the first total grayscale value is less than a first reference value and the second total grayscale value is greater than a second reference value which is greater than the first reference value.

In an embodiment, the first low grayscale may be 0-grayscale.

In an embodiment, the second low grayscale may be 1-grayscale.

In an embodiment, the driving controller may be further configured to change the first low grayscale to the second low grayscale among the grayscales corresponding to the pixels included in the (N+1)-th pixel row when the second total grayscale value is less than the first reference value and the first total grayscale value is greater than the second reference value.

In an embodiment, the first low grayscale may be 0-grayscale.

In an embodiment, the second low grayscale may be 1-grayscale.

Therefore, the driving controller included in the display device and the electronic device may change the 0-grayscale to the 1-grayscale among the grayscales corresponding to the pixels included in the N-th pixel row when the first total grayscale value is less than the first reference value and the second total grayscale value is greater than the second reference value. In addition, the driving controller may change the 0-grayscale to the 1-grayscale among the grayscales corresponding to the pixels included in the (N+1)-th pixel row when the first total grayscale value is greater than the second reference value and the second total grayscale value is less than the first reference value.

The 0-grayscale may be changed to the 1-grayscale, so that the data voltage corresponding to the 0-grayscale may be changed to the data voltage corresponding to the 1-grayscale. The data voltage corresponding to the 0-grayscale is changed to the data voltage corresponding to the 1-grayscale, so that the data voltage may accurately toggle between the data voltage corresponding to the 1-grayscale and the data voltage corresponding to the 255-grayscale for 8-bit image data. Accordingly, the pixels may accurately emit light at the 1-grayscale and the 255-grayscale and display quality of the display device may be improved.

In addition, when the first total grayscale value is less than the first reference value and the second total grayscale value is greater than the second reference value or when the first total grayscale value is greater than the second reference value and the second total grayscale value is less than the first reference value, a user of the display device might not recognize a change of the grayscales.

In addition, a difference between the data voltage corresponding to the 1-grayscale and the data voltage corresponding to the 255-grayscale is less than a difference between the data voltage corresponding to the 0-grayscale and the data voltage corresponding to the 255-grayscale, power consumption of the display device may be reduced.

### BRIEF DESCRIPTION OF THE DRAWINGS

Illustrative, non-limiting embodiments will be more clearly understood from the following detailed description when read in conjunction with the accompanying drawings.

FIG. 1 is a block diagram illustrating a display device according to an embodiment.

FIG. 2 is a graphical diagram illustrating an embodiment of a data voltage generated by a data driver included in the display device of FIG. 1.

FIG. 3 is a circuit diagram illustrating an embodiment of a pixel included in a display panel included in the display device of FIG. 1.

FIG. 4, is a block diagram illustrating an embodiment of the display panel included in the display device of FIG. 1.

FIG. 5 is a tabular diagram illustrating an embodiment of a maximum grayscale value, a first reference value, and a second reference value.

FIG. 6 is a flowchart diagram illustrating an embodiment of an operation of a driving controller included in the display device of FIG. 1.

FIG. 7 is a signal diagram illustrating an embodiment of the operation of the driving controller included in the display device of FIG. 1 further to the embodiment of FIG. 6.

FIG. 8 is a signal diagram illustrating an embodiment of the operation of the driving controller included in the display device of FIG. 1 further to the embodiment of FIG. 6.

FIG. 9 is a graphical diagram illustrating an embodiment of the data voltage transmitted to pixels of FIG. 4.

FIG. 10 is a graphical diagram illustrating an embodiment of the data voltage transmitted to pixels of FIG. 4.

FIG. 11 is a block diagram illustrating an electronic device according to an embodiment.

FIG. 12 is a schematic diagram illustrating multiple configurations of the electronic device of FIG. 11.

### DETAILED DESCRIPTION OF THE EMBODIMENTS

Hereinafter, display devices in accordance with embodiments of the present disclosure will be described in more detail with reference to the accompanying drawings. The same or like reference numerals may be used for the same or like components in the drawings, and redundant descriptions thereof may be omitted.

In an embodiment, a driving controller for a display device may change a 0-grayscale to a 1-grayscale among grayscales corresponding to pixels included in an N-th pixel row when a first total grayscale value of the N-th pixel row is less than a first reference value and a second total grayscale value of an (N+1)-th pixel row is greater than a second reference value, or may change the 0-grayscale to the 1-grayscale among grayscales corresponding to the pixels included in the (N+1)-th pixel row when the first total grayscale value is greater than the second reference value and the second total grayscale value is less than the first reference value.

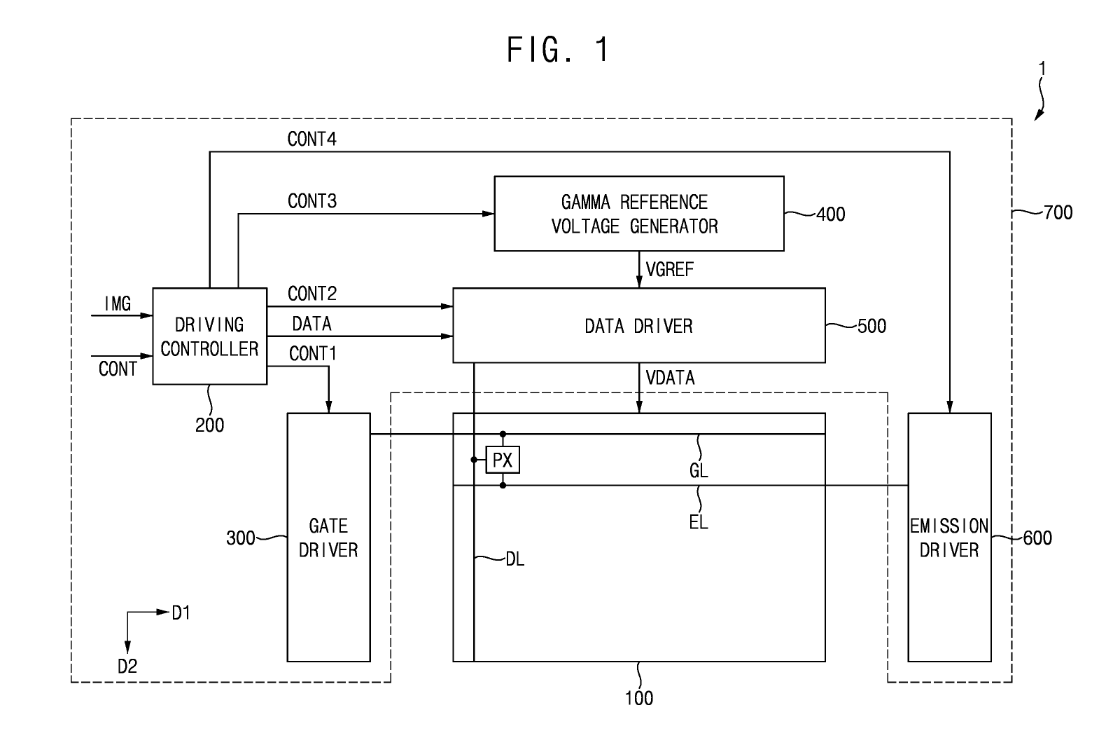

FIG. 1 illustrates a display device 1 according to an embodiment.

Referring to FIG. 1, the display device 1 may include a display panel 100 and a display panel driver 700. The display panel driver 700 may include a driving controller 200, a gate driver 300, a gamma reference voltage generator 400, a data driver 500, and an emission driver 600.

For example, the driving controller 200 and the data driver 500 may be integrated into a single chip, with or without additional circuit integration. For example, the driving controller 200, the gamma reference voltage generator 400, and the data driver 500 may be integrated into a single chip. A driving module including at least the driving controller 200 and the data driver 500 which are integrated into a single chip may be referred to as a timing controller embedded data driver (TED).

The display panel 100 may include a display region on which an image may be displayed and a peripheral region adjacent to the display region. For example, the peripheral region may be referred to as a bezel.

The display panel 100 may include gate lines GL, emission lines EL, data lines DL, and pixels PX. For example, the gate lines GL may extend in a first direction D1, and the emission lines EL may extend substantially parallel to the first direction D1. The data lines DL may extend in a second direction D2 crossing the first direction D1.

The driving controller 200 may receive input image data IMG and an input control signal CONT from an external device. For example, the input image data IMG may include red image data, green image data, and blue image data. In an embodiment, the input image data IMG may further include white image data. In an embodiment, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a gate control signal CONT1, a data control signal CONT2, a gamma control signal CONT3, an emission control signal CONT4, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical start signal and a gate clock signal.

The driving controller 200 may generate the data control signal CONT2 for controlling an operation of the data driver 500 also based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 also based on the input control signal CONT, and may output the gamma control signal CONT3 to the gamma reference voltage generator 400.

The driving controller 200 may generate the emission control signal CONT4 for controlling an operation of the emission driver 600 also based on the input control signal CONT, and may output the emission control signal CONT4 to the emission driver 600.

The gate driver 300 may generate gate signals for transmission to the pixels PX through the gate lines GL in response to the gate control signal CONT1 received from the driving controller 200. The gate driver 300 may output the gate signals to the gate lines GL.

In an embodiment, the gate driver 300 may be integrated with the peripheral region of the display panel 100. In an embodiment, the gate driver 300 may be mounted on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may receive a first maximum voltage and a first minimum voltage. The gamma reference voltage generator 400 may generate a second maximum voltage and a second minimum voltage based on the first maximum voltage and the first minimum voltage. The gamma reference voltage generator 400 may generate the gamma reference voltage VGREF corresponding to a grayscale by dividing the second maximum voltage and the second minimum voltage.

For example, the gamma reference voltage generator 400 may generate the gamma reference voltage VGREF corresponding to a 0-grayscale by dividing the second maximum voltage and the second minimum voltage. For example, the gamma reference voltage generator 400 may generate the gamma reference voltage VGREF corresponding to a 1-grayscale by dividing the second maximum voltage and the second minimum voltage. For example, the gamma reference voltage generator 400 may generate the gamma reference voltage VGREF corresponding to 255-grayscale for 8-bit image data by dividing the second maximum voltage and the second minimum voltage.

Moreover, it shall be understood that the present disclosure is not necessarily limited to 8-bit image data embodiments where a 0-grayscale is black and a 255-grayscale is white. For example, the teachings of the present disclosure may similarly be applied to 12-bit image data embodiments where a 4095-grayscale is white, 16-bit image data embodiments where a 65535-grayscale is white, or N-bit image data embodiments where a (2^N-1)-bit grayscale is white.

In an embodiment, the gamma reference voltage generator 400 may be disposed in the driving controller 200, and/or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital type into data voltages VDATA having an analog type using the gamma reference voltages VGREF. The data driver 500 may output the data voltages VDATA to the data lines DL.

In an embodiment, the data driver 500 may be integrated with the peripheral region of the display panel 100. In an embodiment, the data driver 500 may be mounted onto the peripheral region of the display panel 100.

The emission driver 600 may generate emission signals transmitted to the pixels PX through the emission lines EL in response to the emission control signal CONT4 received from the driving controller 200. The emission driver 600 may output the emission signals to the emission lines EL.

In an embodiment, the emission driver 600 may be integrated with the peripheral region of the display panel 100. In an embodiment, the emission driver 600 may be mounted onto the peripheral region of the display panel 100.

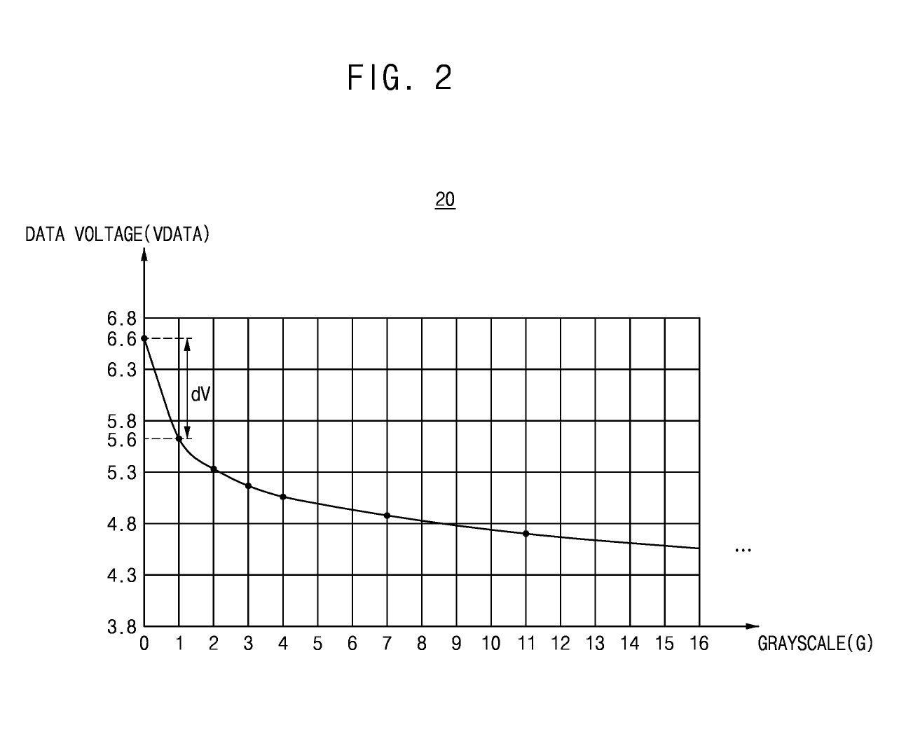

FIG. 2 illustrates an embodiment of the data voltage VDATA generated by the data driver 500 included in the display device 1 of FIG. 1, as indicated generally by the reference numeral 20.

Referring to FIG. 2, the data driver 500 may generate the data voltage VDATA corresponding to the grayscale based on the gamma reference voltage VGREF. Although only grayscale-0 through grayscale-16 are shown for illustrative purposes, it shall be understood that this embodiment handles at least 8-bit image data rather than just 4-bit image data or the like.

In an embodiment, the grayscale of the input image data IMG may be divided into 256 grayscales. For example, the grayscale of the input image data IMG may be divided into the 0-grayscale or 0G to 255-grayscale or 255G. The 0-grayscale may be a minimum grayscale and may correspond to a full black grayscale. The 255-grayscale may be a maximum grayscale and may correspond to a full white grayscale. In addition, the data voltage VDATA corresponding to the 0-grayscale or 0G may be the greatest. Moreover, the data voltage VDATA corresponding to the 255-grayscale or 255G may be the smallest.

The data voltage VDATA corresponding to the 0-grayscale or 0G may be set high to express the 0-grayscale or 0G regardless of characteristics of the pixels PX such as luminance or the like. For example, the data voltage VDATA corresponding to the 0-grayscale or 0G may be about 6.6V. The data voltage VDATA corresponding to the 1-grayscale or 1G may be determined according to the characteristics of the pixels PX such as luminance or the like. For example, the data voltage VDATA corresponding to the 1-grayscale or 1G may be about 5.6V. A difference between the data voltage VDATA corresponding to the 1-grayscale or 1G and the data voltage VDATA corresponding to the 0-grayscale or 0G among the 0-grayscale to the 255-grayscale may be greatest. For example, the difference between the data voltage VDATA corresponding to the 1-grayscale or 1G and the data voltage VDATA corresponding to the 0-grayscale or 0G may be about 1V. Accordingly, a difference between the data voltage VDATA corresponding to the 0-grayscale or 0G and the data voltage VDATA corresponding to the 255-grayscale may be greater than a difference between the data voltage VDATA corresponding to the 1-grayscale or 1G and the data voltage VDATA corresponding to the 255-grayscale.

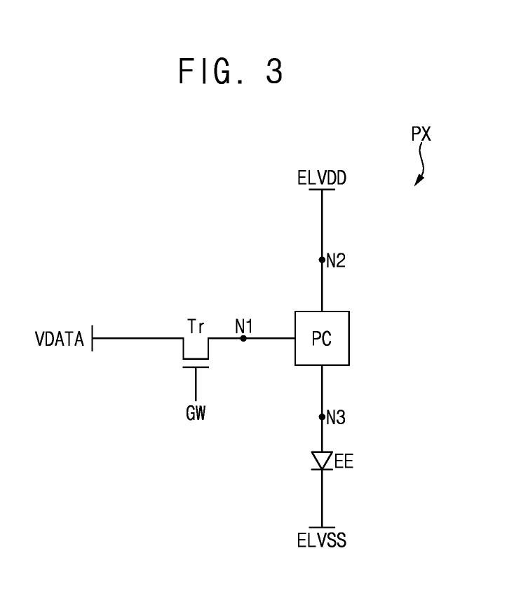

FIG. 3 illustrates an embodiment of the pixel PX included in the display panel 100 included in the display device 1 of FIG. 1.

Referring to FIG. 3, the pixel PX may include a driving circuit PC, a data writing transistor Tr, and a light-emitting element EE.

The data writing transistor Tr may include a control electrode which receives a writing gate signal GW, a first electrode which receives the data voltage VDATA, and a second electrode connected to a first node N1.

The data writing transistor Tr may transmit the data voltage VDATA to the first node N1 in response to the writing gate signal GW having an activation level (e.g., a high level).

A driving circuit PC may be connected to the first node N1, a second node N2, and a third node N3. The driving circuit PC may include a driving transistor which generates a driving current corresponding to the data voltage VDATA.

In an embodiment, the driving circuit PC may include transistors and capacitors. For example, the driving circuit PC may include one driving transistor, five transistors, and two capacitors. For example, the driving circuit PC may include one driving transistor, four non-driving transistors, and two capacitors. For example, the driving circuit PC may include one transistor and one capacitor, but the driving circuit PC is not necessarily limited thereto.

A first power supply voltage terminal may be connected to the second node N2. The driving circuit PC may receive the first power supply voltage ELVDD.

The light emitting element EE may include an anode connected to the third node N3 and a cathode connected to a second power supply voltage terminal. The cathode of the light emitting element EE may receive a second power supply voltage ELVSS.

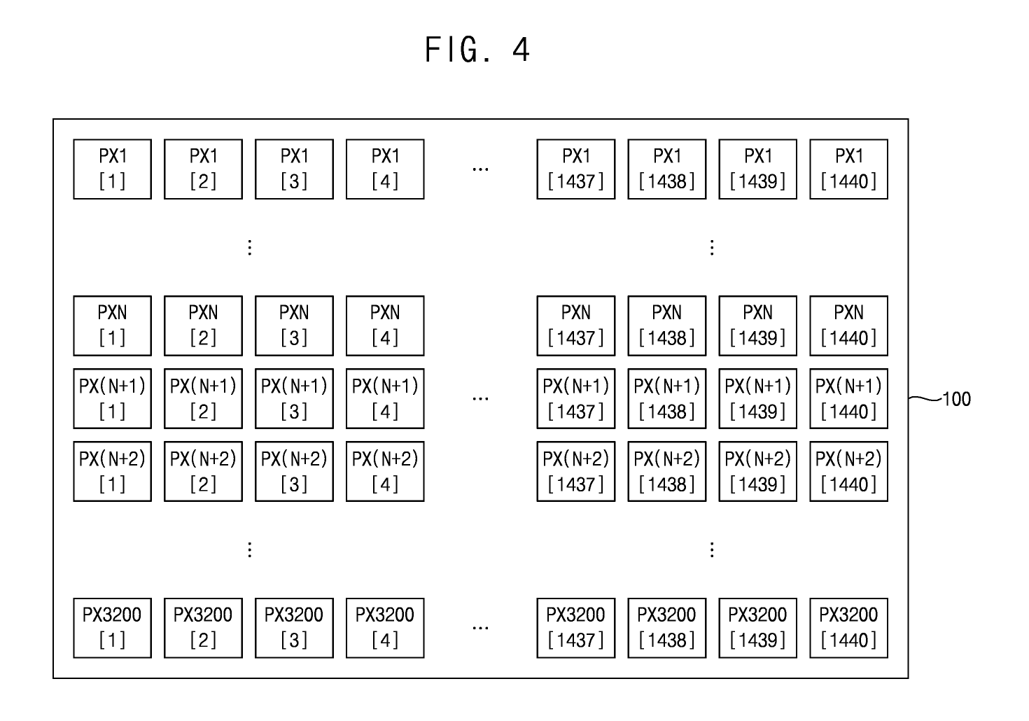

FIG. 4 illustrates an embodiment of the display panel 100 included in the display device 1 of FIG. 1.

Referring to FIG. 4, the display panel 100 may include the pixels PX and natively support 3200 by 1440 pixel screen resolution. In an embodiment, the display panel 100 may include the pixels PX which emit light of a first color (e.g., a red color), the pixels PX which emit light of a second color (e.g., a green color), and the pixels PX which emit light of a third color (e.g., a blue color). An operation of the driving controller 200 for each of the pixels PX which emit light of the first color, the pixels PX which emit light of the second color, and the pixels PX which emit light of the third color may be identical to each other. In addition, the number of each of the pixels PX which emit light of the first color, the number of each of the pixels PX which emit light of the second color, and the number of each of the pixels PX which emit light of the third color may be substantially the same as each other. Accordingly, for convenience of explanation, it will be described below with respect to the pixels PX which emit light of the first color.

In an embodiment, the display panel 100 may include K pixel rows and M pixel columns, where K is a positive integer greater and M is a positive integer. For convenience of explanation, it is assumed that the display panel 100 may include 3,200 pixel rows and 1,440 pixel columns. The display panel 100 may include 4,608,000 pixels PX which emit light of the first color.

For example, a first pixel row may include first to 1440-th pixels PX1[1] to PX1 which emit light of the first color. For example, an N-th pixel row may include first to 1440-th pixels PXN[1] to PXN which emit light of the first color, where N is a positive integer less than or equal to 3200. For example, an (N+1)-th pixel row may include first to 1440-th pixels PX(N+1)[1] to PX(N+1) which emit light of the first color. For example, an (N+2)-th pixel row may include first to 1440-th pixels PX(N+2)[1] to PX(N+2) which emit light of the first color. For example, a 3200-th pixel row may include first to 1440-th pixels PX3200[1] to PX3200 which emit light of the first color.

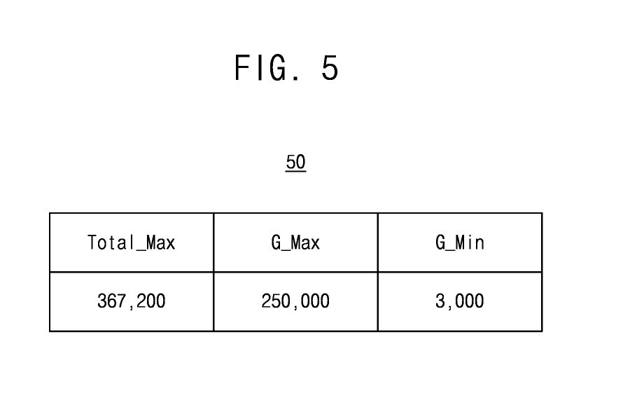

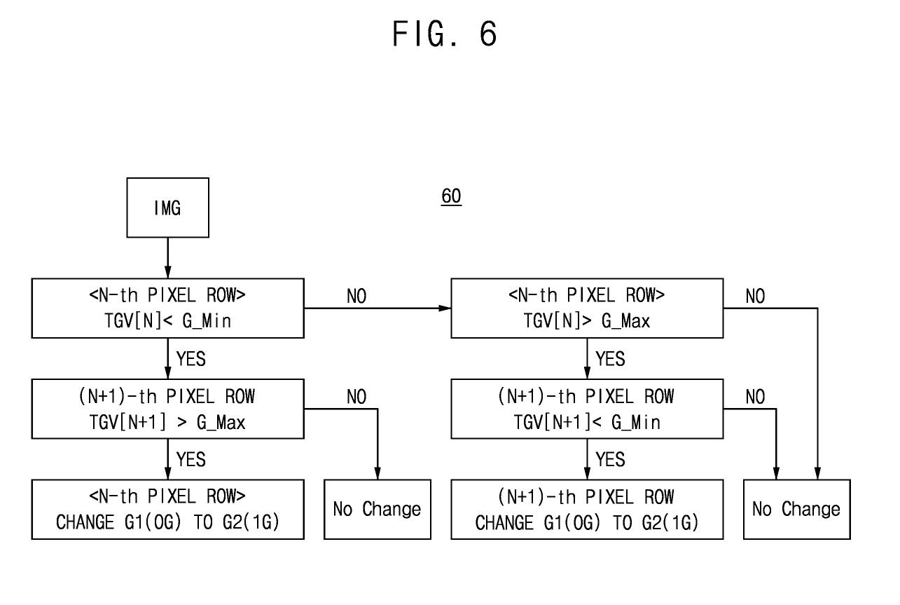

FIG. 5 illustrates an embodiment of a maximum grayscale value Total_Max, a first reference value G_Min, and a second reference value G_Max, as indicated generally by the reference numeral 50. FIG. 6 illustrates an embodiment of an operation of the driving controller 200 included in the display device 1 of FIG. 1, as indicated generally by the reference numeral 60.

Referring to FIGS. 5 and 6, the maximum grayscale value Total_Max is the sum of the grayscale values of each of the pixels PX included in the one pixel row when the grayscale corresponding to each of the pixels PX included in the one pixel row is the maximum grayscale. In addition, the first reference value G_Min may be less than the second reference value G_Max.

In addition, the grayscale of the input image data IMG may be divided into the 256 grayscales. For example, the grayscale of the input image data IMG may be divided into the 0-grayscale or 0G to 255-grayscale. The maximum grayscale is the 255-grayscale and the minimum grayscale is the 0-grayscale or 0G. The 255-grayscale may correspond to the full white grayscale and the 0-grayscale or 0G may correspond to the black grayscale.

The maximum grayscale value Total_Max may be calculated by [equation 1], “Total_Max=A*M”, where Total_Max denotes the maximum grayscale value Total_Max, A denotes the maximum grayscale, and M denotes the number of pixels PX in one pixel row. For example, when the display panel 100 includes M pixel columns, the one pixel row may include M pixels PX. In an embodiment, when the number of the pixel columns is 1,440 and the maximum grayscale is the 255-grayscale, the maximum grayscale value Total_Max may be 367,200, which is 255 multiplied by 1,440.

The driving controller 200 may determine the first reference value G_Min. For example, the driving controller 200 may determine the first reference value G_Min based on a look-up table (LUT) indexed by Total_Max as shown in FIG. 5.

In addition, the driving controller 200 may determine the second reference value G_Max. For example, the driving controller 200 may determine the second reference value G_Max based on the LUT.

The first reference value G_Min may be B% of the maximum grayscale value Total_Max, where B is a real number greater than zero and less than 50. In addition, the second reference value G_Max may be C% of the maximum grayscale value Total_Max, where C is a real number greater than 50 and less than 100. The first reference value G_Min may be less than the second reference value G_Max. For example, when the maximum grayscale value Total_Max is 367200, the B is about 0.816%, and the C is about 68%, the first reference value G_Min may be about 3,000 and the second reference value G_Max may be about 250,000.

The driving controller 200 may determine a first total grayscale value TGV[N] by summing the grayscales corresponding to each of the pixels PXN[1] to PXN included in the N-th pixel row based on the input image data IMG.

The driving controller 200 may determine a second total grayscale value TGV[N+1] by summing the grayscales corresponding to each of the pixels PX(N+1)[1] to PX(N+1) included in the (N+1)-th pixel row, based on the input image data IMG.

The driving controller 200 may compare the first total grayscale value TGV[N] and the first reference value G_Min. When the first total grayscale value TGV[N] is less than the first reference value G_Min, the driving controller 200 may compare the second total grayscale value TGV[N+1] and the second reference value G_Max. When the second total grayscale value TGV[N+1] is greater than the second reference value G_Max, the driving controller 200 may change a first low grayscale G1 to a second low grayscale G2 among the grayscales corresponding to each of the pixels PXN[1] to PXN included in the N-th pixel row. For example, when the first total grayscale value TGV[N] is less than the first reference value G_Min and the second total grayscale value TGV[N+1] is greater than the second reference value G_Max, the driving controller 200 may change the first low grayscale G1 to the second low grayscale G2 among the grayscales corresponding to each of the pixels PXN[1] to PXN included in the N-th pixel row. For example, the first low grayscale G1 may be the 0-grayscale or 0G and the second low grayscale G2 may be the 1-grayscale or 1G.

The grayscales corresponding to each of the pixels PX(N+1)[1] to PX(N+1) included in the (N+1)-th pixel row need not be changed.

When the first total grayscale value TGV[N] is less than the first reference value G_Min and the second total grayscale value TGV[N+1] is less than the second reference value G_Max, the grayscales corresponding to each of the pixels PXN[1] to PXN included in the N-th pixel row and the grayscales corresponding to each of the pixels PX(N+1)[1] to PX(N+1) included in the (N+1)-th pixel row need not be changed.

When the first total grayscale value TGV[N] is greater than the first reference value G_Min, the driving controller 200 may compare the first total grayscale value TGV[N] and the second reference value G_Max. When the first total grayscale value TGV[N] is greater than the second reference value G_Max, the driving controller 200 may compare the second total grayscale value TGV[N+1] and the first reference value G_Min. When the second total grayscale value TVG[N+1] is less than the first reference value G_Min, the driving controller 200 may change the first low grayscale G1 to the second low grayscale G2 among the grayscales corresponding to each of the pixels PX(N+1)[1] to PX(N+1) included in the (N+1)-th pixel row. For example, when the first total grayscale value TGV[N] is greater than the second reference value G_Max and the second total grayscale value TGV[N+1] is less than the first reference value G_Max, , the driving controller 200 may change the first low grayscale G1 to the second low grayscale G2 among the grayscales corresponding to each of the pixels PX(N+1)[1] to PX(N+1) included in the (N+1)-th pixel row. For example, the first low grayscale G1 may be the 0-grayscale or 0G and the second low grayscale G2 may be the 1-grayscale or 1G.

The grayscales corresponding to each of the pixels PXN[1] to PXN included in the N-th pixel row need not be changed.

When the first total grayscale value TGV[N] is greater than the first reference value G_Min and the first total grayscale value TGV[N] is less than the second reference value G_Max, the grayscales corresponding to each of the pixels PXN[1] to PXN included in the N-th pixel row and the grayscales corresponding to each of the pixels PX(N+1)[1] to PX(N+1) included in the (N+1)-th pixel row need not be changed.

In addition, when the first total grayscale value TGV[N] is greater than the second reference value G_Max and the second total grayscale value TGV[N+1] is greater than the first reference value G_Min, the grayscales corresponding to each of the pixels PXN[1] to PXN included in the N-th pixel row and the grayscales corresponding to each of the pixels PX(N+1)[1] to PX(N+1) included in the (N+1)-th pixel row need not be changed.

In an embodiment, the driving controller 200 may calculate a difference between the first total grayscale value TGV[N] and the second total grayscale value TGV[N+1]. When the difference between the first total grayscale value TGV[N] and the second total grayscale value TGV[N+1] is greater than or equal to a third reference value, the driving controller 200 may change the first low grayscale G1 to the second low grayscale G2 among the grayscales corresponding to each of the pixels PXN[1] to PXN included in the N-th pixel row or the grayscales corresponding to each of the pixels PX(N+1)[1] to PX(N+1) included in the (N+1)-th pixel row. For example, the first low grayscale G1 may be the 0-grayscale or 0G and the second grayscale G2 may be the 1-grayscale or 1G. For example, the third reference value is D% of the maximum grayscale value Total_Max, where D is a real number. For example, when the total grayscale value Total_Max is 367200 and the D% is about 67%, the third reference value may be about 246,024.

For example, the first total grayscale value TGV[N] may be less than the second total grayscale value TGV[N+1]. When the difference between the first total grayscale value TGV[N] and the second total grayscale value TGV[N+1] is greater than or equal to the third reference value, the driving controller 200 may change the first low grayscale G1 to the second low grayscale G2 among the grayscales corresponding to each of the pixels PXN[1] to PXN included in the N-th pixel row. The first low grayscale G1 may be the 0-grayscale or 0G and the second grayscale G2 may be the 1-grayscale or 1G.

For example, the first total grayscale value TGV[N] may be less than the second total grayscale value TGV[N+1]. When the difference between the first total grayscale value TGV[N] and the second total grayscale value TGV[N+1] is greater than or equal to the third reference value, the driving controller 200 may change the first low grayscale G1 to the second low grayscale G2 among the grayscales corresponding to each of the pixels PX(N+1)[1] to PX(N+1) included in the (N+1)-th pixel row. The first low grayscale G1 may be the 0-grayscale or 0G and the second grayscale G2 may be the 1-grayscale or 1G.

Although the embodiment shown and described indicates calculating and comparing the first total grayscale value before at least comparing the second total grayscale value, embodiments are not limited thereto. For example, the second total grayscale value may be calculated and compared before at least comparing the first total grayscale value. Moreover, although at least one of the first or second total grayscale values is calculated before its first comparison, the other of the first or second total grayscale values may but need not be calculated unless actually needed, such as upon reaching at least one YES branch of a decision tree in FIG. 6, which may result in reduced power consumption, reduced heat generation, or the like.

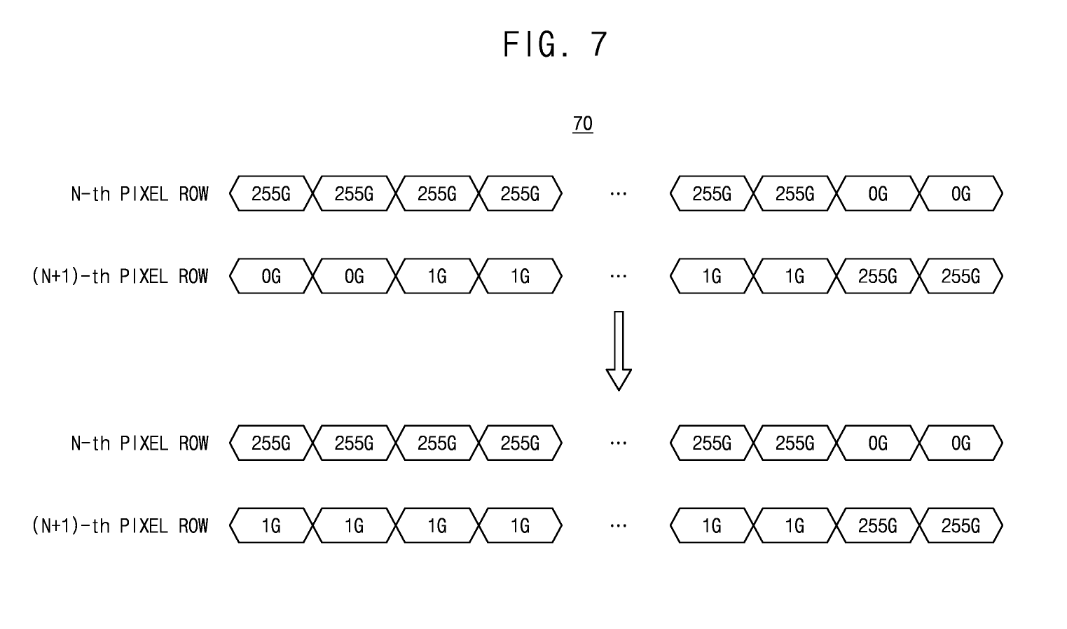

FIG. 7 illustrates an embodiment of the operation of the driving controller 200 included in the display device 1 of FIG. 1 according to the block diagram of FIG. 6, as indicated generally by the reference numeral 70.

Referring to the embodiment of FIG. 7, the grayscales corresponding to the first to 1438-th pixels PXN[1] to PXN included in the N-th pixel row may each be the 255-grayscale or 255G. In addition, the grayscale corresponding to the 1439-th pixel PXN included in the N-th pixel row and the grayscale corresponding to the 1440-th pixel PXN included in the N-th pixel row may each be the 0-grayscale or 0G.

In addition, the grayscale corresponding to the first pixel PX(N+1)[1] included in the (N+1)-th pixel row and the grayscale corresponding to the second pixel PX(N+1)[2] included in the (N+1)-th pixel row may each be the 0-grayscale or 0G. The grayscales corresponding to the third pixel PX(N+1)[3] to the 1438-th pixel PX(N+1) included in the (N+1)-th pixel row may each be the 1-grayscale or 1G. The grayscale corresponding to the 1439-th pixel PX(N+1) included in the (N+1)-th pixel row and the grayscale corresponding to the 1440-th pixel PX(N+1) included in the (N+1)-th pixel row may each be the 255-grayscale or 255G.

The first reference value G_Min may be 3,000 and the second reference value G_Max may be 250,000.

In addition, the number of 255-grayscale pixels among the grayscales corresponding to each of the pixels PXN[1] to PXN included in the N-th pixel row may be 1,438, the number of the 0-grayscale or 0G pixels may be two, and the first total grayscale value TGV[N] may be 366,690.

In addition, the number of 255-grayscale pixels among the grayscales corresponding to each of the pixels PX(N+1)[1] to PX(N+1) included in the (N+1)-th pixel row may be two, the number of 1-grayscale or 1G pixels may be 1,436, the number of the 0-grayscale or 0G pixels may be two, and the second total grayscale value TGV[N+1] may be 1,946.

For example, the first total grayscale value TGV[N] may be greater than the second reference value G_Max and the second total grayscale value TGV[N+1] may be less than the first reference value G_Min. Accordingly, the driving controller 200 may change the 0-grayscale or 0G to the 1-grayscale or 1G among the grayscales corresponding to each of the pixels PX(N+1)[1] to PX(N+1) included in the (N+1)-th pixel row. For example, the driving controller 200 may change the grayscale corresponding to first pixel PX(N+1)[1] included in the (N+1)-th pixel row and the grayscale corresponding to the second pixel PX(N+1)[2] included in the (N+1)-th pixel row from the 0-grayscale or 0G to the 1-grayscale or 1G.

The first total grayscale value TGV[N] is greater than the second reference value G_Max and the second total grayscale value TGV[N+1] is less than the first reference value G_Min, so that a user of the display device 1 might not recognize a change of the grayscales when the grayscale corresponding to first pixel PX(N+1)[1] included in the (N+1)-th pixel row and the grayscale corresponding to the second pixel PX(N+1)[2] included in the (N+1)-th pixel row are changed from the 0-grayscale or 0G to the 1-grayscale or 1G.

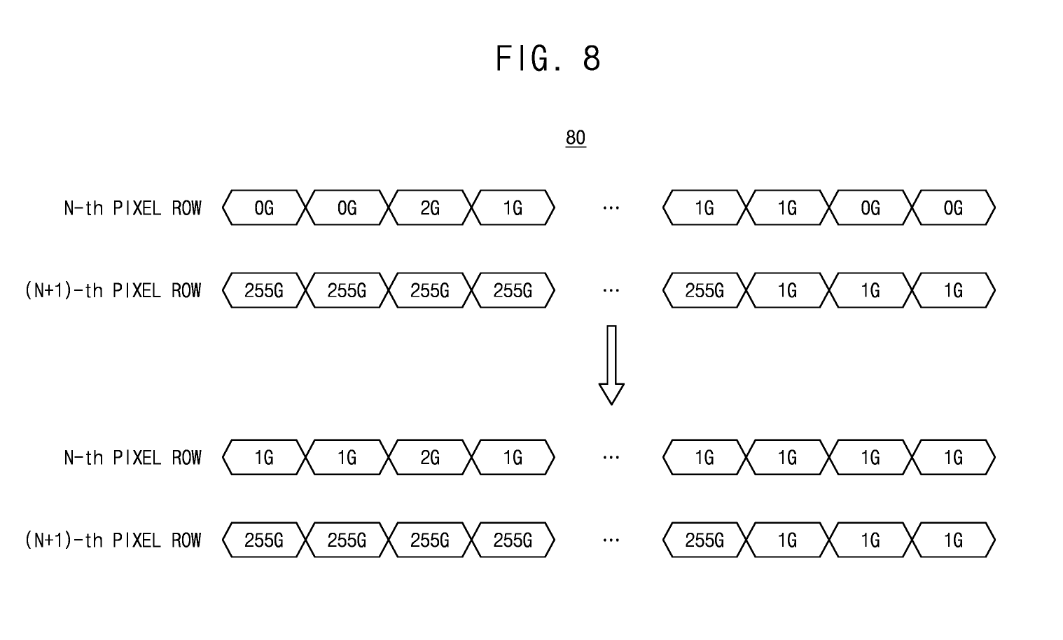

FIG. 8 illustrates an embodiment of the operation of the driving controller 200 included in the display device 1 of FIG. 1 according to the block diagram of FIG. 6, as indicated generally by the reference numeral 80.

Referring to FIG. 8, the grayscale corresponding to the first pixel PXN[1] included in the N-th pixel row, the grayscale corresponding to the second pixel PXN[2] included in the N-th pixel row, the grayscale corresponding to the 1439-th pixel PXN included in the N-th pixel row, and the grayscale corresponding to the 1440-th pixel PXN included in the N-th pixel row may be the 0-grayscale or 0G. The grayscale corresponding to the third pixel PXN[3] included in the N-th pixel row may be the 2-grayscale or 2G. The grayscales corresponding to the fourth pixel PXN[4] to the 1438-th pixel PXN included in the N-th pixel row may be the 1-grayscale or 1G.

In addition, the grayscales corresponding to each of the first pixel PX(N+1)[1] to the 1437-th pixel PX(N+1) included in the (N+1)-th pixel row may be the 255-grayscale or 255G. The grayscales corresponding to each of the 1438-th pixel PX(N+1) to the 1440-th pixel PX(N+1) included in the (N+1)-th pixel row may be the 1-grayscale or 1G.

The first reference value G_Min may be 3,000 and the second reference value G_Max may be 250,000.

In addition, the number of 2-grayscale pixels among the grayscales corresponding to each of the pixels PXN[1] to PXN included in the N-th pixel row may be one, the number of the 1-grayscale or 1G pixels may be 1,435, the number of the 0-grayscale or 0G pixels may be four, and the first total grayscale value TGV[N] may be 1,437.

In addition, the number of 255-grayscale pixels among the grayscales corresponding to each of the pixels PX(N+1)[1] to PX(N+1) included in the (N+1)-th pixel row may be 1,437, the number of 1-grayscale or 1G pixels may be three, and the second total grayscale value TGV[N+1] may be 366,438.

For example, the first total grayscale value TGV[N] may be less than the first reference value G_Min and the second total grayscale value TGV[N+1] may be greater than the second reference value G_Max. Accordingly, the driving controller 200 may change the 0-grayscale or 0G to the 1-grayscale or 1G among the grayscales corresponding to each of the pixels PXN[1] to PXN included in the N-th pixel row. For example, the driving controller 200 may change the grayscale corresponding to the first pixel PXN[1] included in the N-th pixel row, the grayscale corresponding to the second pixel PXN[2] included in the N-th pixel row, the grayscale corresponding to the 1439-th pixel PXN included in the N-th pixel row, and the grayscale corresponding to the 1440-th pixel PXN included in the N-th pixel row from the 0-grayscale or 0G to the 1-grayscale or 1G.

The first total grayscale value TGV[N] is less than the first reference value G_Min and the second total grayscale value TGV[N+1] is greater than the second reference value G_Max, so that the user of the display device 1 need not recognize the change of the grayscales when the grayscale corresponding to the first pixel PXN[1] included in the N-th pixel row, the grayscale corresponding to the second pixel PXN[2] included in the N-th pixel row, the grayscale corresponding to the 1439-th pixel PXN included in the N-th pixel row, and the grayscale corresponding to the 1440-th pixel PXN included in the N-th pixel row are changed from the 0-grayscale or 0G to the 1-grayscale or 1G.

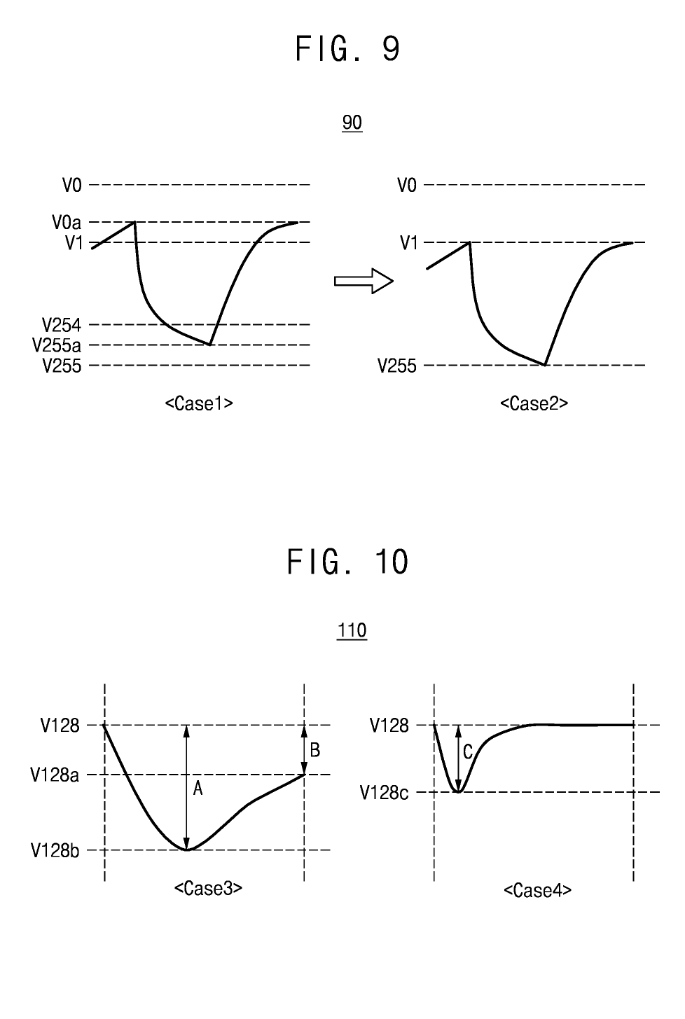

FIG. 9 illustrates an embodiment of the data voltage VDATA transmitted to pixels PX of FIG. 4, as indicated generally by the reference numeral 90.

Referring to FIG. 9, in a first case Case1, the data voltage VDATA may toggle between the data voltage V0 corresponding to the 0-grayscale or 0G and the data voltage V255 corresponding to the 255-grayscale or 255G. In a second case Case2, the data voltage VDATA may toggle between the data voltage V1 corresponding to the 1-grayscale or 1G and the data voltage V255 corresponding to the 255-grayscale or 255G.

In the first case Case1, delays may occur at an edge of the display panel 100. Accordingly, the data voltage VDATA may increase to a first data voltage V0a less than the data voltage V0 corresponding to the 0-grayscale or 0G at the edge of the display panel 100. In addition, the data voltage VDATA may decrease to a second data voltage V255a greater than the data voltage V255 corresponding to the 255-grayscale or 255G at the edge of the display panel 100. For example, the data voltage VDATA may toggle between the first data voltage V0a and the second data voltage V255a at the edge of the display panel 100. The data voltage VDATA toggles between the first data voltage V0a and the second data voltage V255a, so that the pixels PX might not accurately emit light at the 0-grayscale or 0G and the 255-grayscale or 255G.

In the second case Case2, when the driving controller 200 change the 0-grayscale or 0G to the 1-grayscale or 1G among the grayscales corresponding to each of the pixels PX, the data voltage VDATA may toggle between the data voltage V1 corresponding to the 1-grayscale or 1G and the data voltage V255 corresponding to the 255-grayscale or 255G. The data voltage V1 corresponding to the 1-grayscale or 1G may be less than the data voltage V0 corresponding to the 0-grayscale or 0G. Accordingly, regardless of the delays which occur at the edge of the display panel 100, the data voltage VDATA may increase to the data voltage V1 corresponding to the 1-grayscale or 1G. In addition, the data voltage VDATA may decrease to the data voltage V255 corresponding to the 255-grayscale or 255G. Accordingly, the pixels PX may accurately emit light at the 1-grayscale or 1G and the 255-grayscale or 255G.

The pixels PX accurately emit light at the 1-grayscale or 1G and the 255-grayscale or 255G, so that display quality of the display device 1 may be improved.

In addition, the data voltage VDATA toggles between the data voltage V1 corresponding to the 1-grayscale or 1G and the data voltage V255 corresponding to the 255-grayscale or 255G, so that power consumption of the display device 1 may be reduced compared to when the data voltage VDATA toggles between the data voltage V0 corresponding to the 0-grayscale or 0G and the data voltage V255 corresponding to the 255-grayscale or 255G.

In addition, when the first total grayscale value TGV[N] is less than the first reference value G_Min and the second total grayscale value TGV[N+1] is greater than the second reference value G_Max, the driving controller 200 may change the 0-grayscale or 0G to the 1-grayscale or 1G among the grayscales corresponding to the pixels PXN[1] to PXN included in the N-th pixel row. The first total grayscale value TGV[N] is less than the first reference value G_Min and the second total grayscale value TGV[N+1] is greater than the second reference value G_Max, so that the user of the display device 1 might not recognize the change of the grayscales.

In addition, when the first total grayscale value TGV[N] is greater than the second reference value G_Max and the second total grayscale value TGV[N+1] is less than the first reference value G_Min, the driving controller 200 may change the 0-grayscale or 0G to the 1-grayscale or 1G among the grayscales corresponding to the pixels PX(N+1)[1] to PX(N+1) included in the (N+1)-th pixel row. The first total grayscale value TGV[N] is greater than the second reference value G_Max and the second total grayscale value TGV[N+1] is less than the first reference value G_Min, so that the user of the display device 1 might not recognize the change of the grayscales.

FIG. 10 illustrates an embodiment of the data voltage VDATA transmitted to pixels PX of FIG. 4, as indicated generally by the reference numeral 110.

Referring to FIG. 10, the data voltage VDATA for a first side of the one pixel row may be the data voltage VDATA corresponding to the first grayscale and the data voltage VDATA for a second side of the one pixel row may toggle between the data voltage VDATA corresponding to a low grayscale and the data voltage VDATA corresponding to a high grayscale. For convenience of explanation, it is assumed that the first grayscale is the 128-grayscale.

In an embodiment, in a third case Case3, the data voltage VDATA for the first side of the N-th pixel row may be the data voltage V128 corresponding to the 128-grayscale and the data voltage VDATA for the second side of the N-th pixel row may toggle between the data voltage V0 corresponding to the 0-grayscale or 0G and the data voltage V255 corresponding to the 255-grayscale or 255G.

When the data voltage VDATA for the second side of the N-th pixel row toggles between the data voltage V0 corresponding to the 0-grayscale or 0G and the data voltage V255 corresponding to the 255-grayscale or 255G, a ripple phenomenon may be caused by a difference between the data voltage V0 corresponding to the 0-grayscale or 0G and the data voltage V255 corresponding to the 255-grayscale or 255G. The gamma reference voltage VGREF may be momentarily decreased by the ripple phenomenon.

The gamma reference voltage VGREF is momentarily decreased, so that the data voltage V128 corresponding to the 128-grayscale may be decreased. The data voltage V128 corresponding to the 128-grayscale of the first side of the N-th pixel row may be decreased to a third data voltage V128b. A difference between the data voltage V128 corresponding to the 128-grayscale and the third data voltage V128b may be a first difference value A.

The third data voltage V128b may be increased to a fourth data voltage V128a lower than the data voltage V128 corresponding to the 128-grayscale. A difference between the data voltage V128 corresponding to the 128-grayscale and the fourth data voltage V128a may be a second difference value B. The third data voltage V128b is not increased to the data voltage V128 corresponding to the 128-grayscale, so that the pixels PX included in the first side of the N-th pixel row might not emit light at the 128-grayscale.

In a fourth case Case4, the data voltage VDATA for the first side of the N-th pixel row may be the data voltage V128 corresponding to the 128-grayscale. In addition, when the first total grayscale value TGV[N] is less than the first reference value G_Min and the second total grayscale value TGV[N+1] is greater than the second reference value G_Max, the driving controller 200 may change the 0-grayscale or 0G to the 1-grayscale or 1G among the grayscales corresponding to each of the pixels PXN[1] to PXN included in the N-th pixel row. Accordingly, the data voltage VDATA for the second side of the N-th pixel row may toggle between the data voltage V1 corresponding to the 1-grayscale or 1G and the data voltage V255 corresponding to the 255-grayscale or 255G.

The difference between the data voltage V1 corresponding to the 1-grayscale or 1G and the data voltage V255 corresponding to the 255-grayscale or 255G may be less than the difference between the data voltage V0 corresponding to the 0-grayscale or 0G and the data voltage V255 corresponding to the 255-grayscale or 255G.

When the data voltage VDATA for the second side of the N-th pixel row toggles between the data voltage V1 corresponding to the 1-grayscale or 1G and the data voltage V255 corresponding to the 255-grayscale or 255G, the gamma reference voltage VGREF may be momentarily decreased by the ripple phenomenon.

The gamma reference voltage VGREF is momentarily decreased, so that the data voltage V128 corresponding to the 128-grayscale may be decreased. The data voltage V128 corresponding to the 128-grayscale of the first side of the N-th pixel row may be decreased to a fifth data voltage V128c. A difference between the data voltage V128 corresponding to the 128-grayscale and the fifth data voltage V128c may be a third difference value C.

The difference between the data voltage V1 corresponding to the 1-grayscale or 1G and the data voltage V255 corresponding to the 255-grayscale or 255G is less than the difference between the data voltage V0 corresponding to the 0-grayscale or 0G and the data voltage V255 corresponding to the 255-grayscale or 255G, so that the third difference value C may be less than the first difference value A.

The third difference value C is less than the first difference value A, so that the fifth data voltage V128c may be increased to the data voltage V128 corresponding to the 128-grayscale.

The fifth data voltage V128c is increased to the data voltage V128 corresponding to the 128-grayscale, so that the pixels PX included in the first side of the N-th pixel row may emit light at the 128-grayscale. The pixels PX included in the first side of the N-th pixel row emit light at the 128-grayscale, the display quality of the display device 1 may be improved.

In addition, the data voltage VDATA for the second side of the N-th pixel row toggles between the data voltage V1 corresponding to the 1-grayscale or 1G and the data voltage V255 corresponding to the 255-grayscale or 255G, the power consumption of the display device 1 may be reduced compared to when the data voltage VDATA toggles between the data voltage V0 corresponding to the 0-grayscale or 0G and the data voltage V255 corresponding to the 255-grayscale or 255G.

In addition, when the first total grayscale value TGV[N] is less than the first reference value G_Min and the second total grayscale value TGV[N+1] is greater than the second reference value G_Max, the driving controller 200 may change the 0-grayscale or 0G to the 1-grayscale or 1G among the grayscales corresponding to the pixels PXN[1] to PXN included in the N-th pixel row. The first total grayscale value TGV[N] is less than the first reference value G_Min and the second total grayscale value TGV[N+1] is greater than the second reference value G_Max, so that the user of the display device 1 might not recognize the change of the grayscales.

In an embodiment, in the third case Case3, the data voltage VDATA for the first side of the (N+1)-th pixel row may be the data voltage V128 corresponding to the 128-grayscale and the data voltage VDATA for the second side of the (N+1)-th pixel row may toggle between the data voltage V0 corresponding to the 0-grayscale or 0G and the data voltage V255 corresponding to the 255-grayscale or 255G.

When the data voltage VDATA for the second side of the (N+1)-th pixel row toggles between the data voltage V0 corresponding to the 0-grayscale or 0G and the data voltage V255 corresponding to the 255-grayscale or 255G, the ripple phenomenon may be caused by the difference between the data voltage V0 corresponding to the 0-grayscale or 0G and the data voltage V255 corresponding to the 255-grayscale or 255G. The gamma reference voltage VGREF may be momentarily decreased by the ripple phenomenon.

The gamma reference voltage VGREF is momentarily decreased, so that the data voltage V128 corresponding to the 128-grayscale of the first side of the (N+1)-th pixel row may be decreased. The data voltage V128 corresponding to the 128-grayscale of the first side of the (N+1)-th pixel row may be decreased to the third data voltage V128b. The difference between the data voltage V128 corresponding to the 128-grayscale and the third data voltage V128b may be the first difference value A.

The third data voltage V128b may be increased to the fourth data voltage V128a lower than the data voltage V128 corresponding to the 128-grayscale. The difference between the data voltage V128 corresponding to the 128-grayscale and the fourth data voltage V128a may be the second difference value B. The third data voltage V128b is not increased to the data voltage V128 corresponding to the 128-grayscale, so that the pixels PX included in the first side of the (N+1)-th pixel row might not emit light at the 128-grayscale.

In the fourth case Case4, the data voltage VDATA for the first side of the (N+1)-th pixel row may be the data voltage V128 corresponding to the 128-grayscale. In addition, when the first total grayscale value TGV[N] is greater than the second reference value G_Max and the second total grayscale value TGV[N+1] is less than the first reference value G_Min, the driving controller 200 may change the 0-grayscale or 0G to the 1-grayscale or 1G among the grayscales corresponding to each of the pixels PX(N+1)[1] to PX(N+1) included in the (N+1)-th pixel row. Accordingly, the data voltage VDATA for the second side of the (N+1)-th pixel row may toggle between the data voltage V1 corresponding to the 1-grayscale or 1G and the data voltage V255 corresponding to the 255-grayscale or 255G.

The difference between the data voltage V1 corresponding to the 1-grayscale or 1G and the data voltage V255 corresponding to the 255-grayscale or 255G may be less than the difference between the data voltage V0 corresponding to the 0-grayscale or 0G and the data voltage V255 corresponding to the 255-grayscale or 255G.

When the data voltage VDATA for the second side of the (N+1)-th pixel row toggles between the data voltage V1 corresponding to the 1-grayscale or 1G and the data voltage V255 corresponding to the 255-grayscale or 255G, the gamma reference voltage VGREF may be momentarily decreased by the ripple phenomenon.

The gamma reference voltage VGREF is momentarily decreased, so that the data voltage V128 corresponding to the 128-grayscale of the first side of the (N+1)-th pixel row may be decreased. The data voltage V128 corresponding to the 128-grayscale of the first side of the (N+1)-th pixel row may be decreased to the fifth data voltage V128c. The difference between the data voltage V128 corresponding to the 128-grayscale and the fifth data voltage V128c may be the third difference value C.

The difference between the data voltage V1 corresponding to the 1-grayscale or 1G and the data voltage V255 corresponding to the 255-grayscale or 255G is less than the difference between the data voltage V0 corresponding to the 0-grayscale or 0G and the data voltage V255 corresponding to the 255-grayscale or 255G, so that the third difference value C may be less than the first difference value A.

The third difference value C is less than the first difference value A, so that the fifth data voltage V128c may be increased to the data voltage V128 corresponding to the 128-grayscale.

The fifth data voltage V128c is increased to the data voltage V128 corresponding to the 128-grayscale, so that the pixels PX included in the first side of the (N+1)-th pixel row may emit light at the 128-grayscale. The pixels PX included in the first side of the (N+1)-th pixel row emit light at the 128-grayscale, the display quality of the display device 1 may be improved.

In addition, the data voltage VDATA for the second side of the (N+1)-th pixel row toggles between the data voltage V1 corresponding to the 1-grayscale or 1G and the data voltage V255 corresponding to the 255-grayscale or 255G, the power consumption of the display device 1 may be reduced compared to when the data voltage VDATA toggles between the data voltage V0 corresponding to the 0-grayscale or 0G and the data voltage V255 corresponding to the 255-grayscale or 255G.

In addition, when the first total grayscale value TGV[N] is greater than the second reference value G_Max and the second total grayscale value TGV[N+1] is less than the first reference value G_Min, the driving controller 200 may change the 0-grayscale or 0G to the 1-grayscale or 1G among the grayscales corresponding to the pixels PX(N+1)[1] to PX(N+1) included in the (N+1)-th pixel row. The first total grayscale value TGV[N] is greater than the second reference value G_Max and the second total grayscale value TGV[N+1] is less than the first reference value G_Min, so that the user of the display device 1 might not recognize the change of the grayscales.

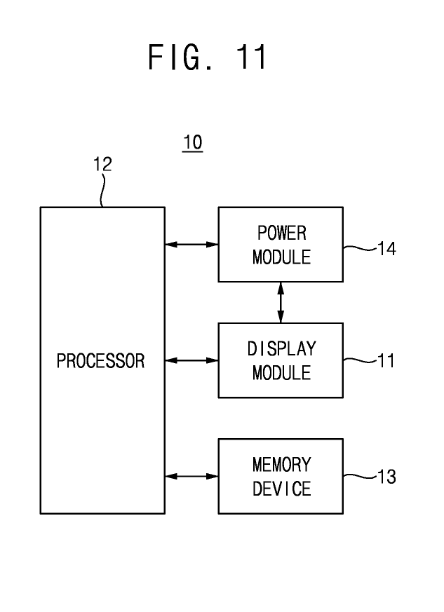

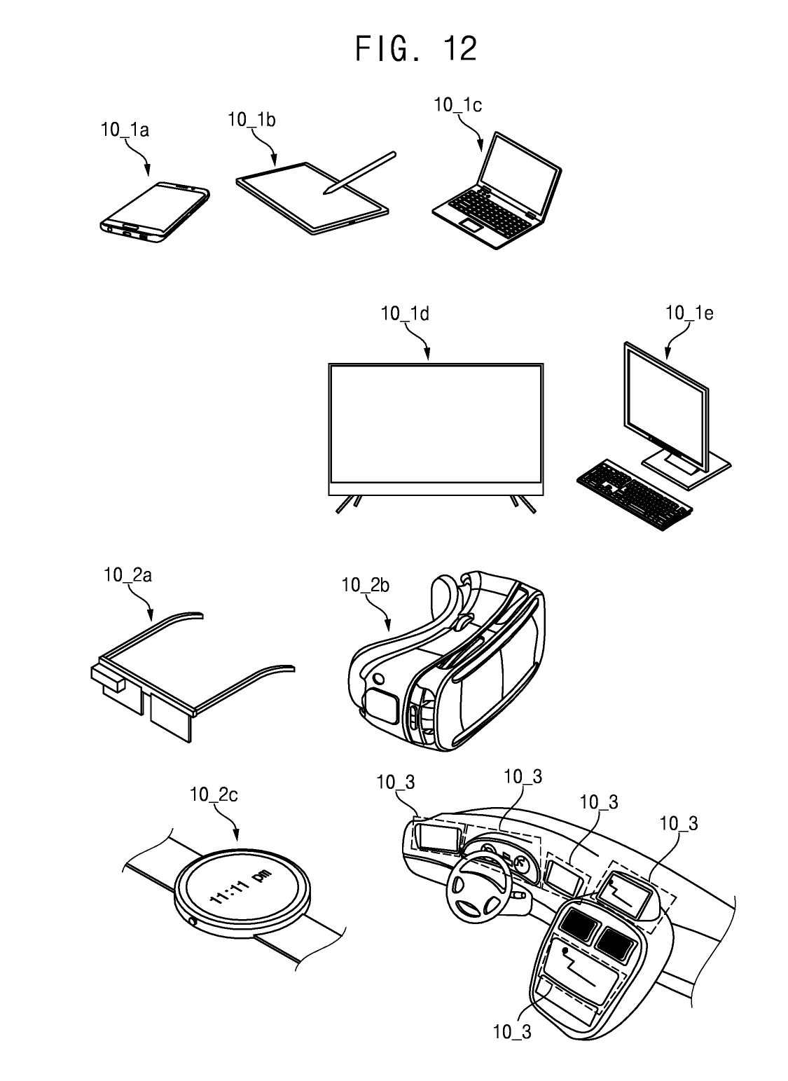

FIG. 11 illustrates an electronic device 10 according to embodiments. FIG. 12 illustrates multiple configurations of the electronic device 10 of FIG. 11.

Referring to FIG. 11, the electronic device 10 may include a display module 11, a processor 12, a memory device 13, and a power module 14.

The display device 1 may be applied to various electronic devices. In an embodiment, the electronic device 10 may include the display device 1 of FIG. 1. In an embodiment, an operation of the display device 1 included in the electronic device 10 may be substantially the same as an operation of the display device 1 described with reference FIGS. 1 to 10. In an embodiment, the electronic device 10 may further include modules or devices having other additional functions in addition to the display device 1.

The processor 12 may include at least one of a central processing unit (CPU), an application processor (AP), a graphics processing unit (GPU), front-end processor (FEP), a communications processor (CP), an image signal processor (ISP), and/or a controller. The processor 12 may include one or more processors.

In an embodiment, the processor 12 may provide the input control signal CONT of FIG. 1 and the input image data IMG of FIG. 1 to the driving controller 200 included in the display device 1 of FIG. 1.

In an embodiment, the processor 12 may be provided as two or more component forms in terms of functionality and/or structure. For example, the processor 12 may include a main processor in the form of a first driving chip including a central processing unit, and an auxiliary processor in the form of a second driving chip including a controller that receives an image signal from the main processor and processes the image signal to conform with interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one of a non-volatile memory (NVM) device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 13 may include a power supply module, such as a power adapter and/or a battery device, and a power conversion module that converts power supplied by the power supply module and generates power in a format suitable for the operation of the electronic device 10.

At least one of the components of the electronic device 10 may be included in the display device 1. In addition, some of individual modules functionally included in one module may be included in the display device 1 and others may be provided separately from the display device 1. For example, the display device 1 may include the display module 11 and the processor 12. The memory device 13 and the power module 14 may be provided in the form of other devices in the electronic device 10, such as other than the display device 1.

Referring to FIG. 12, multiple configurations of an electronic device such as the electronic device 10, each having a display device such as the display device 1, may include an image display electronic device such as a smart phone 10_1a, a tablet computer 10_1b, a laptop/notebook computer 10_1c, a television (TV) 10_1d, a computer monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not necessarily limited to the image display electronic device, the wearable electronic device and the vehicle electronic device 10_3.

The present disclosures may be applied to a display device and an electronic device including the display device. For example, the present disclosures may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, or the like.

The foregoing is illustrative of the present disclosure and is not to be construed as limiting thereof. Although embodiments of the present disclosure have been shown and described, those of ordinary skill in the pertinent art will readily appreciate that many modifications are possible in the disclosed and alternate embodiments without materially departing from the novel teachings and advantages of the present disclosure. Accordingly, all such modifications are intended to be included within the scope of the present disclosure as defined in the claims. In these claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, but that modifications to the disclosed embodiments, as well as other embodiments, are intended to be included within the scope of the appended claims. The scope of present disclosure is defined by the following claims, with equivalents of the claims to be included therein.

What is claimed is:

1. A display device comprising:
a display panel having a plurality of pixels;
a data driver configured to provide data voltages to the plurality of pixels; and
a driving controller configured to control the data driver,
wherein the driving controller is further configured to:
calculate a first total grayscale value by summing grayscales corresponding to pixels of the plurality of pixels included in an N-th pixel row, where N is a positive integer;
calculate a second total grayscale value by summing grayscales corresponding to pixels of the plurality of pixels included in an (N+1)-th pixel row; and
change a first low grayscale to a second low grayscale among the grayscales corresponding to the pixels included in the N-th pixel row when the first total grayscale value is less than a first reference value and the second total grayscale value is greater than a second reference value which is greater than the first reference value.

2. The display device of claim 1, wherein the first low grayscale is 0-grayscale.

3. The display device of claim 2, wherein the second low grayscale is 1-grayscale.

4. The display device of claim 1, wherein the driving controller is further configured to change the first low grayscale to the second low grayscale among the grayscales corresponding to the pixels included in the (N+1)-th pixel row when the second total grayscale value is less than the first reference value and the first total grayscale value is greater than the second reference value.

5. The display device of claim 4, wherein the first low grayscale is 0-grayscale.

6. The display device of claim 5, wherein the second low grayscale is 1-grayscale.

7. The display device of claim 1, wherein the plurality of pixels are configured to emit light of a substantially same color.

8. A display device comprising:
a display panel having a plurality of pixels;
a data driver configured to provide data voltages to the plurality of pixels; and
a driving controller configured to control the data driver,
wherein the driving controller is further configured to:
calculate a first total grayscale value by summing grayscales corresponding to pixels of the plurality of pixels included in an N-th pixel row, where N is a positive integer;
calculate a second total grayscale value by summing grayscales corresponding to pixels of the plurality of pixels included in an (N+1)-th pixel row; and
change a first low grayscale to a second low grayscale among the grayscales corresponding to the pixels included in the (N+1)-th pixel row when the second total grayscale value is less than a first reference value and the first total grayscale value is greater than a second reference value which is greater than the first reference value.

9. The display device of claim 8, wherein the first low grayscale is 0-grayscale.

10. The display device of claim 9, wherein the second low grayscale is 1-grayscale.

11. The display device of claim 8, wherein the driving controller is further configured to change the first low grayscale to the second low grayscale among the grayscales corresponding to the pixels included in the N-th pixel row when the first total grayscale value is less than the first reference value and the second total grayscale value is greater than the second reference value.

12. The display device of claim 11, wherein the first low grayscale is 0-grayscale.

13. The display device of claim 12, wherein the second low grayscale is 1-grayscale.

14. The display device of claim 8, wherein the pixels are configured to emit light of a substantially same color.

15. An electronic device comprising:
a processor configured to generate an input control signal and input image data;
a memory device configured to store data information for an operation of the processor;
a display panel having a plurality of pixels;
a data driver configured to provide data voltages to the plurality of pixels; and
a driving controller configured to control the data driver based on the input control signal and the input image data,
wherein the driving controller is further configured to:
calculate a first total grayscale value by summing grayscales corresponding to pixels of the plurality of pixels included in an N-th pixel row, where N is a positive integer;
calculate a second total grayscale value by summing grayscales corresponding to pixels of the plurality of pixels included in an (N+1)-th pixel row; and
change a first low grayscale to a second low grayscale among the grayscales corresponding to the pixels included in the N-th pixel row when the first total grayscale value is less than a first reference value and the second total grayscale value is greater than a second reference value which is greater than the first reference value.

16. The electronic device of claim 15, wherein the first low grayscale is 0-grayscale.

17. The electronic device of claim 16, wherein the second low grayscale is 1-grayscale.

18. The electronic device of claim 15, wherein the driving controller is further configured to change the first low grayscale to the second low grayscale among the grayscales corresponding to the pixels included in the (N+1)-th pixel row when the second total grayscale value is less than the first reference value and the first total grayscale value is greater than the second reference value.

19. The electronic device of claim 18, wherein the first low grayscale is 0-grayscale.

20. The electronic device of claim 19, wherein the second low grayscale is 1-grayscale.
